(19) United States
(12) Patent Application Publication
(10) Pub. No.: US 2004/0102585 A1
(43) Pub. Date: May 27, 2004

(54) Graft polymers or graft copolymers

(76) Inventors: Alan Lawrence Steinmetz, Louisville, KY (US); Norbert Schall, Forstern (DE); Klaus Dziwok, Freilassing (DE); Helmut Coutelle, Freising (DE); Wolfgang Simon, Neufahrn (DE); Stefan Dick, Weichering (DE); Inge Kramer, Freising (DE)

Correspondence Address: Scott R Cox, Lynch Cox Gilman & Mahan, Suite 2200, 400 West Market Street, Louisville, KY, 40202, US

(21) Appl. No.: 10/343,790

(22) PCT Filed: Aug. 2, 2001
(86) PCT No.: PCT/EP01/08940

(30) Foreign Application Priority Data
Aug. 4, 2000 (DE) 100 38 147.2

(51) Int. Cl. C08F 283/00

(52) U.S. Cl. 525/510

(57) ABSTRACT

Graft polymers or copolymers of the structural type are described

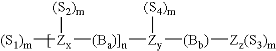

in which (Bₐ) and (B_{b}) denote the same or different predominantly unpolar base polymer chains, optionally with free valences to form a crosslinked structure; Z_{X}, Z_{y} and Z_{Z} denote the same or different central units, optionally with free valences to form a crosslinked structure; (S₁),(S₂),(S₃) and (S₄) denote the same or different polar or nonpolar side chains; m =1-10 and n is a whole number from 0 to 5000 and the structure is saturated by polar terminal groups, characterized by the fact that the central unit Z_{X} Z_{y} and Z_{Z} represents an aminoplastic central unit based on a melamine-formaldehyde or urea-formaldehyde resin.

### DESCRIPTION

The invention concerns graft polymers or copolymers containing an aminoplast central unit.

Graft polymers generally consist of a main chain and “grafted-on” side chains. Graft copolymers contains two or more base polymer units in the main chain, onto which structurally different side chains are grafted. The type, number and length of the grafted-on side chains essentially determine the features of this substance group. The side chains can be coupled to the functional groups of the main chain, whereby one or more branches can form.

Graft polymers or copolymers can be produced according to a method in which polymerization is continued on an already macromolecular compound using a differently configured polymer whose molecules are grafted onto the chain of the macromolecule as a side chain. A functional group, for example, can be introduced into the main chain so that there is one such group for about 25 to 100 monomers. The functional group can optionally be further converted so that polymerization of monomers that form the final side chain can occur on it.

Graft polymers and copolymers are used in a wide variety of applications, for example, in binder systems for paints and lacquers, as wetting agents and adhesion promoters. An essential feature is the “linear” main chain equipped with functional groups on which the side chains can be attached.

An overview of this substance class can be found in IUPAC — Inf. Bull No. 30 (1967, p. 27).

Examples of mostly linear graft copolymers are known from EP-A-830 409, EP-A-835 251, EP-A-859 755 and in 5,629,373 and 5,627,232.

The conversion of an aminoplastic central unit with an alkylene oxide polymer (for example, polyethylene glycol) is described in these patents, in which a copolymer is obtained. Such copolymers contain, bonded to the aminoplastic central unit, a nonfunctional side chain of the formula (RO)ₚ in which R represents hydrogen, an alkyl group with 1 to 4 carbon atoms or an acyl group with 1 to 4 carbon atoms and p denotes a positive number, which is equal to the free valence of the arninoplastic central unit minus 2. The obtained graft polymers are generally water-soluble. However, there is the hazard that during introduction of functional groups, a three-dimensional crosslinking will occur so that the forming polymer becomes water-insoluble.

U.S. Pat. Nos. 5,627,232, 5,629,373 and 5,914,373 describe linear aminoplastic-ether copolymers of the formula

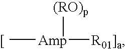

in which the divalent group R₀₁ represents a divalent alkylenoxy-containing group, Amp denotes the skeletal group of an aminoplastic resin, R denotes hydrogen, an alkyl group with 1 to 4 carbon atoms and an acyl group with 1 to 4 carbon atoms, p is a positive number corresponding to the free valence of Amp -2, RO is bonded to the alkylene units of Amp and a is a number greater than 1.

The linear aminoplast-ether copolymers can be used in water-containing compositions or in coating compositions. The linear aminoplastic-ether copolymers are water-soluble and can optionally also contain hydrophobic side groups. The special case of a graft copolymer for use in aqueous systems is described, especially for application of a thickener.

EP-A-565 924 describes powdered coating compositions with an amino resin based on glycoluril. The amino resin compound is used as a curing agent in a coating powder. Grafting is not described. The central unit is referred to as “crosslinker”, which means that this material is known in principle for crosslinking other monomers and therefore constructing three-dimensional networks. The production of defined graft polymer structures that are first isolated and then can be used as an independent additive is not described.

EP-A-320 689 describes nonaqueous dispersions of microparticles of a homopolymer from aminoplastic and polyol. The purpose is production of a dispersion with particles of the most uniform possible molecular weight distribution. The aminoplastic-polyol condensation products are described as difficult to produce in the desired form. The precise structure of the resulting polymer is not described, nor are any of the different graftings of the main polymer.

EP-B-3 18 939 concerns a similar object, which represents the basis for EP-A-220 689 in a less detailed disclosure. Again no grafting is mentioned.

U.S. Pat. No. 4,271,277 describes the use of glycoluril as a curing agent for coating powders. The resulting cured coating powder is a structurally undescribed homopolymer without grafting. The purpose of the invention is to improve the coating powders that form by crosslinking with aminoplastics by addition of special catalysts.

U.S. Pat. No. 4,229,400 describes aminoplastic/polyethylene oxide homopolymers in which graft polymers are not involved. The purpose is production of improved printing plates.

The object of the present invention is to provide graft polymers or copolymers which are essentially linear and which may be cross-lined only under certain circumstances and which, by the incorporation of the variable side chain, may be modified simply and purpose-oriented such that they may be used in non-polar systems. This object is solved according to the invention by graft polymers or copolymers of the structural type.

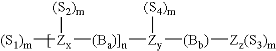

in which (Bₐ) and (B_{b}) denote the same or different predominantly non-polar base polymer chains, optionally with free valences to form a crosslinked structure; Z_{X}, Z_{y} and Z_{z} denote the same or different central units, optionally with free valences to form a crosslinked structure; (S₁), (S₂),(S₃) and (S₄) denote the same or different polar or nonpolar side chains; m =1 to 10 and n is an integer from 0 to 5000 and the structure is saturated by arbitrary terminal groups, wherein the central unit Z_{X}, Z_{y}, and Z_{Z} is an aminoplast central unit on the basis of a melamine-formaldehyde or ureaformaldehyde resin.

The use of this substance group is very versatile, in which the possibility for modification of the graft polymers or copolymers is not restricted to the use of high polymers, but the forming products can also be polymers still soluble in water or in solvents. The main chain of the graft polymer or copolymer is essentially a linear molecule. This is produced by the fact that at least bifunctional molecule is polymerized or polycondensed, for example, a diisocyanate, a diester, a dicarboxylic acid, a dicarboxylic acid anhydride, a diol, a lactone, a lactam, or another bifunctional compound from the group of silanes or siloxanes.

In the simplest case, the side chains are different terminal groups (terminating end groups). In graft polymers or copolymers with a very high molecular weight, however, modification via the terminal groups is not sufficient in order to significantly alter the molecular properties of these products. This can only be expected at relatively low molecular weight, for example, from 10,000 to 100,000 dalton. In higher molecular graft polymers or copolymers, the introduction of functional groups is necessary.

Production of graft polymers or copolymers can occur in a usual manner, for example, in solvents, in water or by direct conversion of the “components” with or without the aid of a catalyst.

All these conversions are relatively demanding and exhibit the following shortcomings:

The introduction of side chains with functional groups is generally not simple, since, during addition of the side chain molecule either transverse crosslinking occurs at the outset and no graft polymer is therefore formed or, during addition after formation of the linear base skeleton, the necessary reactivity of the side chain is absent. For this reason, a demanding two or multistage method is generally considered in which the necessary reaction centers must be created first, for example, by “pre-oxidation” of a PE base polymer chain, onto which a side chain can then be attached.

The production of graft polymers according to usual methods also has the drawback that the side chains only exhibit a statistical distribution after radical or radiation-induced polymerization.

It has now surprisingly been found that some of these shortcomings can be circumvented, if the mostly linear graft polymers or copolymers contain aminoplastic central units. This is all the more so surprising, since the substances normally react under acid catalysis with other functional groups containing active hydrogen, like alcohols, thiols, carboxylic acids, acid amides, carbamates, etc. and crosslink the oligomers and/or polymers three-dimensionally. For this reason, these materials are used in a number of applications as “crosslinking components” or “curing agents”, for example, in coating compositions. However, it was surprisingly found that these aminoplastic central units can nevertheless be used to produce mostly linear graft polymers or copolymers (the statement “mostly linear” then refers by definition to the base polymer).

It is possible according to the invention to couple the base polymer chain mostly linearly via the aminoplastic central units and to modify the properties of the polymer by grafting on corresponding different side chains. Just as in the known water-soluble graft copolymers, by appropriate choice of side chains the resulting HLB (hydrophilic-lipophilic balance) can be deliberately adjusted.

If the area of application according to the invention is a nonpolar medium, like a polyethylene or polypropylene, a mostly nonpolar base polymer is used, for example, long-chain and terminal diol, a polyethylene glycol, polypropylene glycol, polytetrahydrofuran or combinations or block polymers thereof, or a polyethylene wax with terminal OH groups.

The aminoplast central unit is preferably constructed from monomers of the formula

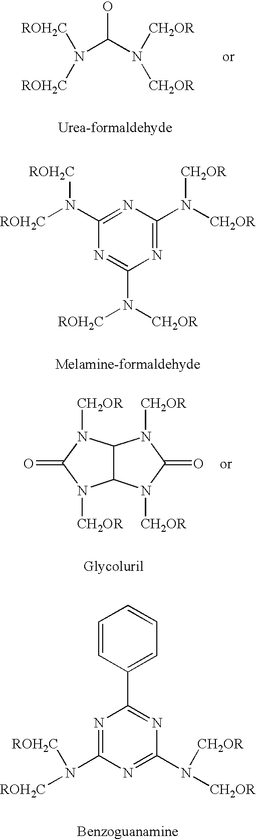

in which R represents a lower alkyl group, preferably a methyl or ethyl group.

The base polymer chain (Bₐ),(B_{b}) and (B_{c}) preferably represents a polyalkylene, for example, a polyethylene or polypropylene group, a predominantly unpolar polyoxyalkylene, for example, a polyoxypropylene, polyoxybutylene, polytetrahydrofuran group; a polyurethane group, a polyoxyacrylate or methacrylate group, a polycarbonate and/or a polysiloxane group.

According to a preferred variant, at least one side chain (S₁), (S₂) and (S₃) has a surfactant structure with a polar and nonpolar end and is capable of reaction with the central unit Z_{X}, Z_{y} and Z_{z} via an OH group.

In the graft polymers or copolymers according to the invention, the side groups (S₁), (S₂) and (S₃) can be selected from hydrophobic and/or hydrophilic side groups of one-sided alkyl-terminated polyethylene/polypropylene copolymers, saturated or unsaturated C₉-C₃₆ alkyl ethoxylates, CH₃-O-[CH₂-CH₂-O-]pH, Alk-O[CH(CH₃)CH₂O-]ₚH wherein “Alk” comprise an alkyl group; CH₃-(CH₂)ₙCH=CH(CH₂)ₘ-CH₂OH (n, m, p 1 to 500)

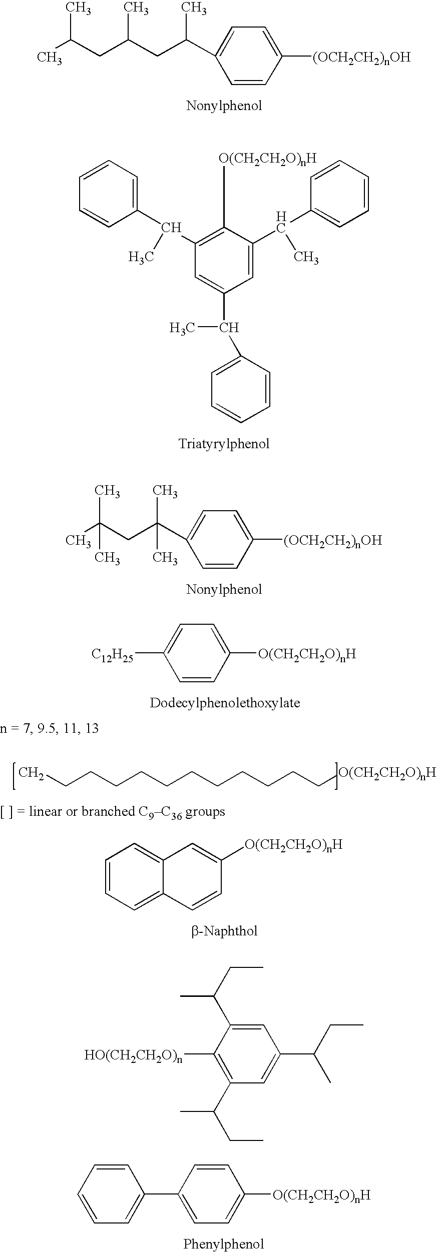

In the graft polymers or copolymers, n preferably represents an integer from 1 to 500, especially 1 to 100, and more preferably, 1 to 10.

The base polymer chains (Bₐ) and (B_{b}) in the graft polymers or copolymers according to the invention can be essentially nonpolar, and the side chains (S₁) to (S₄) can be essentially polar. The graft polymers or copolymers according to the invention can also be present in solid or liquid form and their molecular weight lies between about 1000 and 10,000,000, preferably between about 1000 and 1,000,000.

The object of the invention is also a method for production of the graft polymers and copolymers just described, characterized by the fact that the monomers or prepolymers are converted with each other in the usual manner, either in solution in water or in an organic solvent, in emulsion or suspension or by direct conversion of the components in bulk or in powder form in a melt, by polymerization, polyaddition, polycondensation with or without catalysts, preferably in a one-stage process.

From the possibility of adjusting and deliberately varying the HLB value or surface tension of the forming graft polymer or copolymer by appropriate choice of the base polymer and side chain, a variety of different applications result.

The object of the invention is therefore also generally the use of the already mentioned graft polymers or copolymers dissolved in an organic solvent, or into a liquid or powder form.

Because of the gradable adjustment of the HLB value, use of these materials is possible in emulsion polymerization in order to control and stabilize drop size and thus influence the molecular weight. An object of the invention is therefore also the use of the graft polymers or copolymers according to the invention as emulsifiers in emulsion polymerization.

Moreover, by using side chains with functional groups, the desired properties can be deliberately improved or altered. Thus, a hydrophobic (or hydrophilic) side chain with an additional functional group, like an amino or amido, a nitrile or carboxyl group or an alkylene compound, etc. can be grafted onto the base polymer instead of purely hydrophobic (or hydrophilic) side chains. Amino groups are known, among other things, for the fact that they can be absorbed readily on pigment or filler surfaces and thus exhibit an additional dispersal and/or wetting effect.

The object of the invention is therefore also the use of graft polymers or copolymers according to the invention as adhesive promoters between inorganic or organic pigments and/or filler surfaces and organic polymer matrices.

Two principal possibilities are available for this: either the inorganic surface is pretreated by coupling reagents so that the corresponding reactive groups are prepared for bonding to the graft copolymer or the base chain of the graft copolymer is chosen so that it can interact with the surface of the mineral and “coat” this surface accordingly. Coating of the inorganic surface is also possible by appropriate side chains. The part of the graft copolymer not used for coating of the inorganic surface is then selected so that this part has adequate affinity to the surrounding matrix in polarity and molecular structure.

Examples for hydrophobic groups attached to the base chain are stated in claim 5.

This behavior adapted to the HLB value of the system is mostly useful in liquid formulations, like coating compositions, paints, lacquers, cosmetics and generally in all liquid systems.

The object of the invention is therefore also the use of the graft polymers or copolymers according to the invention as binders for paints, lacquers, glues, glazes, paper coatings and/or drilling fluids.

Double bonds can be involved in the reaction in the polymer system, as is the case, for example, in UV-curing systems. In UV-curing lacquers, the graft copolymer can initially be used as a rheological additive which, however, can be bonded into the polymer structure during UV exposure and forms a component of the film. An entire series of drawbacks that can occur by “foreign components” in an otherwise homogeneous coating film can therefore be avoided, like demixing, floating of the graft copolymer on the surface, etc.

The graft polymers or copolymers according to the invention can also be used, for example, in heat-molded plastics and/or coatings (for example, stoving enamels/powdered coatings or the like) or in acid-curing systems in which the remaining “reactive” groups of the central unit are used for further crosslinking. A uniform polymer that no longer exhibits demixing processes is thus produced from the polymer (plastic/binder molecules), on the one hand, and the graft copolymer, on the other, by incorporation in the newly forming polymer framework. “Implantation” of corresponding hydrophilic groups in an otherwise hydrophobic plastic is also possible, which can make these materials “biodegradable”. An object of the invention is therefore also the use of the graft polymers and copolymers according to the invention as macromonomers with biodegradable groups in a polymer matrix.

Coupling of molecules with reactive and/or functional groups is also possible. Consecutive reactions that permit the head polymer to be used as a support for other components can therefore be conducted. An example of this is stabilization of HALS compounds in an organic matrix in which the later is coupled via a reactive group of the graft copolymer and a corresponding group of sterically hindered amine and can thus be anchored in the organic matrix via the graft copolymer. The graft copolymer of the invention is therefore also considered a potential support that can be linked to other organic materials via reactive groups if corresponding reactive groups are present in this material. Owing to the fact that the polarity, HLB value, molecular weight of the graft copolymer can be adjusted to the matrix properties, anchoring of materials that are in principle incompatible in this matrix is possible by bonding the coupling to the graft copolymer. For example, molecules that absorb UV light can be incorporated in a polymer matrix via the graft copolymer so that these either can be stabilized or made biodegradable via appropriate groups. “Permanent” finishing of plastic fibers with antistatic agents is also possible in this manner. Until now, surfactants that introduce a certain conductivity to the fibers but have the shortcoming that they migrate into the organic matrix and can be washed out have been used for this purpose. A cationic compound (for example, from the group of alkylammonium or phosphonium or sulfonium salts) is often used for this purpose, which, however, also does not permanently remain on (in) the fiber and can also exhibit other negative effects. As a way out, already conducting materials, like graphite, have therefore been used, which, however, cannot always be a solution because of the intrinsic color. Block copolymers have also since been offered as a solution, which have the advantage of not being able to migrate onto the fiber surface as high-molecular substances and therefore remain in the organic matrix. (A review of the underlying mechanisms can be found in the publication of Markus M. Grob et al., in Plastic Additives & Compounding, July 1999, pp. 20 ff.) The use of graft copolymers according to the invention, however, now has the additional advantage that anchoring in the nonpolar matrix can be controlled “merely” via the side chain so that the conducting hydrophilic chain of the organic material need not be interrupted by hydrophobic regions necessary for anchoring, as in the known block polymers. The object of the invention is therefore also the use of the graft polymers and copolymers according to the invention as antistatic agents in a polymer matrix.

The invention is explained nonrestrictively in the following examples.

### EXAMPLE 1

250 g Pluriol® P 4000 (BASF, polypropylene glycol with a molecular weight of about 4000), 26.5 g glycoluril Powderlink® 1174 (Cytec Co.) and 36.5 g Pluriol® A350E (BASF, one-sided methyl-terminated polyethylene glycol with a molecular weight of about 350) are weighed into a 500 mL glass flask. The raw materials are dried at 105° C. in 40 mbar of vacuum for about 3 hours until gases no longer appear. The vacuum is interrupted with nitrogen, whereupon 2.2 g of the catalyst Nacure® 5076 (Worlee, 70% dodecylbenzenesulfonic acid in isopropanol) is added. After reapplication of the vacuum, it is heated to 130° C. with agitation within 1 hour. After about 3 hours of reaction time, the mass becomes so highly viscous that the forming methanol merely escapes as foam. The vacuum is interrupted with nitrogen, whereupon 1.1 g triethanolamine and 0.2 g 2,6-di-tert-butyl-4-methylphenol (antioxidants) are stirred in over 10 minutes. The reaction product is cooled under nitrogen at room temperature. The product is a honey-like, viscous mass that is insoluble or only poorly soluble in water and aliphatic solvent naphtha (Shellsol® D60), soluble with turbidity in aromatic solvent naphtha K30, readily soluble with low viscosity in xylene, butyl acetate, isopropanol and butyl diglycol.

### EXAMPLE 2

2000 g polybutylene glycol (molecular weight about 2900; Poly-THF 2900, BASF), 293 g Powderlink® 1174 (Cytec Co.) and 233 g Pluriolo® A350E (BASF) are weighed into a Sigma mixer. The raw materials are dried at 105° C. in 40 mbar of vacuum during agitation (30 rpm) for about 3 hours until no gases appear. The vacuum is interrupted with nitrogen, whereupon 15.8 g of the catalyst Nacure® 5976 (Worlee, 70% dodecylbenzenesulfonic acid in isopropanol) is added. After reapplication of a vacuum, the reaction medium is kneaded at 30 rpm. After about 50 minutes of reaction time, the mass is highly viscous. The vacuum is interrupted with nitrogen, whereupon 10 g triethanolamine and 1 g 2,6-di-tert-butyl-4-methylphenol (antioxidants) are kneaded in over 10 minutes. The product is a wax-like mass that is insoluble in water, and slowly but readily soluble in xylene.

Application Example Emulsifying effect of the products according to examples 1 and 2:

a) 30 g xylene is mixed in a beaker with 3 g of each of the emulsifiers according to example 1 and 2 and mildly agitated. (The quantity is the solid portion but it is added to a 20 percent solution of Examples 1 and 2 added in water.) 70 g tap water is then added, which is colored with one drop of dye solution Duasyn Acid Rhodamine® B 01 (Hoechst Co.) in water. The mixture is dispersed in an Ultra-Turrax agitator for 2 minutes at 24,000 rpm. The emulsion is filled into a 100 mL upright cylinder and the demixing observed.

Results:

| | | |
|---|---|---|
| Emulsifier | After 1 hour | After 24 hours |
| Blank | Totally demixes | Totally demixes |
| sample | | |
| Example 1 | Stable | Stable, 2 mL water, 1 mL xylene separates |
| Example 2 | Stable | Stable, 3 mL water, no xylene separates |
| Igepal ® | Stable | Stable, 2 mL water, 2 mL xylene separates |
| RC 520* | | |

*Dodecylphenol ethoxylate, Rhodia Co., as comparison.

b) Experiment according to a) but with 30 mL water and 70 mL xylene.

Results:

| Emulsifier | After 1 hour | After 24 hours |
|---|---|---|
| Blank sample | Totally demixes | Totally demixes |
| Example 1 | Stable | Stable, 1 mL xylene separates |
| Example 2 | Stable | Stable, 2 mL xylene separates |
| Igepal ® RC 520* | Largely demixes | Largely demixes, 3 mL water, |
| | | 36 mL emulsion |

### EXAMPLE 3

150 g polytetrahydrofuran (MW about 2900) (BASF AG), 26 g Powderlink® 1174 (Cytec) and 173 g poly(ethylene/butylene)diol (Kraton® liquid Shell AG) are dissolved in toluene in a 2 L reaction vessel and heated to 110° C. under nitrogen. After addition of 1.50 g Nacure® (Worlee, dodecylbenzenesulfonic acid, 70% in isopropanol), toluene is eliminated from the reaction mixture under vacuum (450 mmHg). After 2 hours of reaction time, 0.95 g triethanolamine is added and the product dried overnight. A tacky mass insoluble in water but readily soluble in toluene is formed.

### EXAMPLE 4

60 g polytetrahydrofuran (BASF AG), 8 g Powderlinko 1174 (Cytec) and 21 g Pluriolo A1350P (BASF) are dissolved in toluene in a 1 L reaction vessel and heated to 110° C. under nitrogen for 1 hour. After addition of 1.50 g Nacure® (Worlee, dodecylbenzenesulfonic acid, 70% in isopropanol), toluene is eliminated from the reaction mixture under vacuum (450 mmHg). After 2 hours of reaction time, 0.95 g triethanolamine is added and the product dried overnight. A whitish mass insoluble in water but readily soluble in toluene is formed.

### EXAMPLE 5

60 g polytetrahydrofuran (BASF AG), 8 g Powderlinko 1174 (Cytec) and 124 g polyethylene glycol M5000 (Clariant GmbH) are dissolved in toluene in a 1 L reaction vessel and heated to 110° C. for 1 hour under nitrogen. After addition of 0.85 g Nacureo (Worlee, dodecylbenzenesulfonic acid, 70% in isopropanol), toluene is eliminated from the reaction mixture under vacuum (450 mmHg). After 3.5 hours of reaction time, 0.47 g triethanolamine is added, agitated for 10 minutes and the product dried overnight. A white mass insoluble in water but readily soluble in toluene is formed.

### EXAMPLE 6

60 g polytetrahydrofuran (BASF AG), 8 g Powderlink® 1174 (Cytec) and 49.7 g polyethylene glycol M2000 (Clariant GmbH) are dissolved in toluene in a 1 L reaction vessel and heated to 110° C. for 1 hour under nitrogen. After addition of 0.51 g Nacure® (Worlee, dodecylbenzenesulfonic acid, 70% in isopropanol), toluene is eliminated from the reaction mixture under vacuum (450 mmHg). After 3.5 hours of reaction time, 0.32 g triethanolamine is added, agitated for 10 minutes and the product dried overnight. A white mass insoluble in water but readily soluble in toluene is formed.

21. Graft polymers or copolymers of the structural type 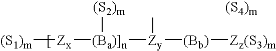
wherein (Bₐ) and (B_{b}) represent the same or different predominantly unpolar base polymer chains; Z_{X}, Z_{y} and Z_{z} represent the same or different central units; each of (S₁), (S₂), (S₃) and (S₄) represent the same or different polar or nonpolar side chains;
wherein m =1-10 and n is an integer from 1 to 5000; wherein the structure is saturated by polar terminal groups; and wherein the central unit Z_{X}, Z_{y} and Z_{Z} each represent an aminoplast central unit based on a melamine-formaldehyde, ureaformaldehyde, glycoluril or benzoguanamine resin.

22. Graft polymers or copolymers of claim 21, wherein the aminoplast central units Z_{X}, Z_{y} and Z_{Z} are constructed from monomers selected from the group consisting of 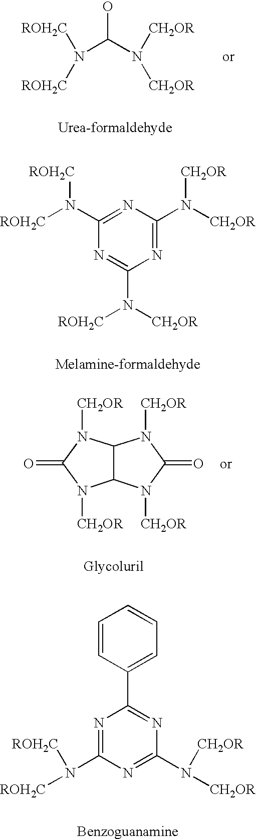
in which R represents a lower alkyl group.

23. Graft polymers or copolymers of claim 21, wherein the base polymer chain (Bₐ), (B_{b}), and (B_{c}) are selected from the group consisting of a polyalkylene group, a polyoxyalkylene group, a polytetrahydrofuran group; a polyurethane group; a polyoxyacrylate or a methacrylate group; a polycarbonate group; and a polysiloxane group.

24. Graft polymers or copolymers of claim 21, wherein at least one side chain, (S₁), (S₂), (S₃) and (S₄) has a surfactant structure with a polar and a nonpolar end which can react with the central unit Zₓ, Z_{y} and Z_{Z} via an OH group.

25. Graft polymers or copolymers of claim 21, wherein the side groups (S₁), (S₂), (S₃) and (S₄) comprise hydrophobic and/or hydrophilic side groups selected from the group consisting of one-sided alkyl-terminated polyethylene/polypropylene copolymers, saturated or unsaturated C₉-C₃₆ alkyl ethoxylates, CH₃-O-[CH₂-CH₂-O]pH, Alk-O-[CH(CH₃)CH₂O-]PH (wherein “Alk” comprises an alkyl group); CH₃-(CH₂)ₙCH=CH-(CH₂)ₘ-CH₂OH (n, m, p =1 to 5),

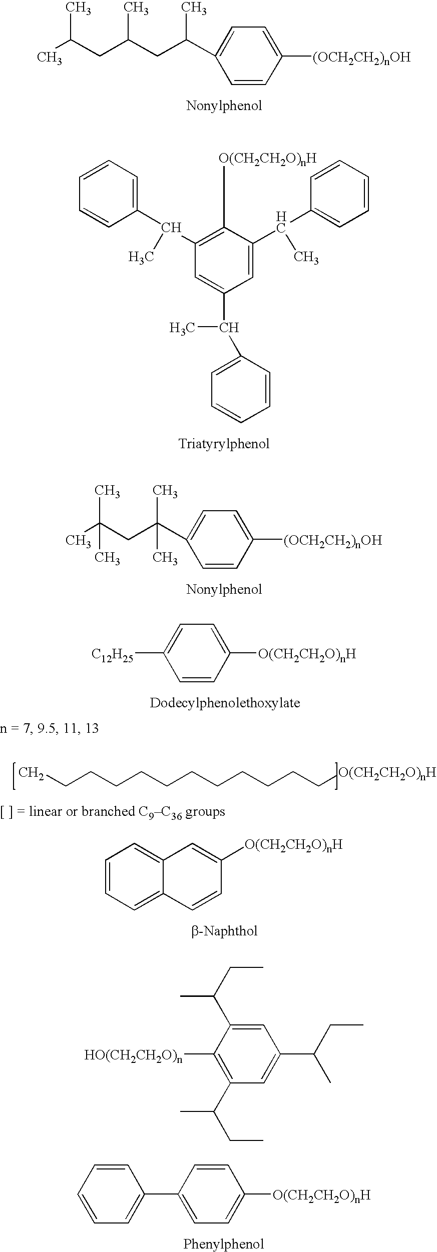

26. Graft polymers or copolymers of claim 21, wherein n is an integer from about 1 to about 500.

27. Graft polymers or copolymers of claim 21, wherein n is an integer from about 1 to about 100.

28. Graft polymers or copolymers of claim 21, wherein the base polymer chains (Bₐ) and (B_{b}) are essentially unpolar, and the side chains (S₁), (S₂) and (S₃) are essentially polar.

29. Graft polymers or copolymers of claim 21 present in solid or liquid form, wherein their molecular weight is between about 1000 and about 10,000,000.

30. Graft polymers or copolymers of claim 21 present in solid or liquid form, wherein their molecular weight is between about 1,000 and about 1,000,000.

31. Graft polymers or copolymers of claim 21, wherein (Bₐ) and (B_{b}) further contain free valences used to permit the formation of a cross-linked structure.

32. Graft polymers or copolymers of claim 21, wherein Z_{X}, Z_{y} and Z_{z} further contain free valences to permit the formation of a cross-linked structure.

33. The process of claim 23 wherein the polyalkylene comprises a polyethylene or a polypropylene group.

34. Graft polymers or copolymers of claim 23, wherein the polyoxyalkylene group comprises a polyoxypropylene or a polyoxybutylene.

35. A binder for paints, lacquers, glues, glazes, and paper coatings comprising the graft polymer or copolymer of claim 21.

36. A cobinder to improve the stability or the film formation properties of a liquid system comprising the graft polymer or copolymer of claim 21.

37. Adhesion promoters between inorganic, or organic pigments and/or filler surfaces and organic polymer matrices comprising the polymer or copolymer of claim 21.

38. An emulsifier or wetting agent in liquid or pasty, gel-like systems, such as cosmetics, personal care products, household cleaners, paints, lacquers and liquid plastics, comprising the graft polymer of claim 21.

39. A mediator bridge in films, plastics or plastic objects that consist of incompatible plastics or polymers comprising the graft polymer or copolymer of claim 21.

40. An emulsifier for emulsion polymerization comprising the polymer or copolymer of claim 21.

41. A macrosurfactant for stabilization of emulsions comprising the graft polymer or copolymer of claim 21.

42. A macromonomer for use with biodegradable groups in a polymer matrix comprising the graft polymer or copolymer of claim 21.

43. An antistatic agent in polymer matrices comprising the graft polymer or copolymer of claim 21.
